(19) United States
(12) Patent Application Publication
(10) Pub. No.: US 2006/0259939 A1
(43) Pub. Date: Nov. 16, 2006

(54) METHOD, SYSTEM AND RECEIVING DEVICE FOR TRANSMITTING SCREEN FRAMES FROM ONE TO MANY TERMINALS

(75) Inventors: Tse-Hung Chu, Hsinchu (TW); Chun-Ming Lai, Hsinchu (TW); Shing-Chung Szu, Hsinchu (TW)

Correspondence Address: PAI PATENT & TRADEMARK LAW FIRM, 1001 FOURTH AVENUE, SUITE 3200, SEATTLE, WA, 98154, US

(73) Assignee: NEWSOFT TECHNOLOGY CORPORATION, Taipei (TW)

(21) Appl. No.: 11/306,696

(22) Filed: Jan. 7, 2006

(30) Foreign Application Priority Data
May 11, 2005 (TW) 94115257

(51) Int. Cl. H04N 7/173; G06F 13/00; H04N 5/445

(52) U.S. Cl. 725/120; 725/38; 725/105

(57) ABSTRACT

A method for transmitting screen frames from one to many terminals is applied to a network system consisting of a first electronic device, a second electronic device, and a third electronic device. The method includes the following steps: the first electronic device transmitting a full screen frame and at least one rectangle data to the second electronic device via network packets, wherein the rectangle data is information of changed areas in the full screen frame; the second electronic device receiving the full screen frame and the rectangle data, and in accordance with each received network packet transmitting an acknowledgement; and the third electronic device intercepting the full screen frame and the rectangle data to reconstruct an updated screen frame for display. A system and a receiving device for transmitting screen frames from one to many terminals are disclosed simultaneously.

### BACKGROUND OF THE INVENTION

1. Field of the Invention

The invention relates to a method, a system and a receiving device for transmitting screen frames and, more particularly, to a method, a system and a receiving device for transmitting screen frames from one to many terminals.

2. Description of the Related Art

Computers have become part of people's daily lives due to the advancement of information technology, and the screen frame on a computer is required to be shared with other users in some occasions such as conferencing. However, there are several problems that need to be overcome due to the limitation of network bandwidth.

Take wireless local area network (WLAN) as an example; transmitting a full-color screen frame of 1024×768 pixels would take up most of the network bandwidth according to the transmission standard of IEEE 802.11a/g. Therefore, transmitting the unprocessed data would take a long time, and transmitting compressed data would result in lower picture quality with high compression rate or unsatisfactory effect with low compression rate. In addition, the problem with occupied network bandwidth becomes more severe during the transmission of screen frames from one to many terminals. And, if screen frames from one to many terminals were to be transmitted via broadcast packet, the error rate is quite high since one characteristic of the broadcast packet is that the receiving terminal does not send back an acknowledgement, therefore satisfactory transmission cannot be achieved. Though wired local area network has wider network bandwidth, enhancing the transmission efficiency of screen frames is a goal which the industry is pursuing.

Concluding from above, there is much room for improvement in terms of how to effectively reduce the data of screen frames for transmission and at the same time transmit the screen frames from one to many terminals.

### BRIEF SUMMARY OF THE INVENTION

In view of the above, an object of the invention is to provide a method, a system, and a receiving device for transmitting screen frames from one to many terminals, which effectively reduces the data quantity of screen frames for transmission and transmits the screen frames from one to many terminals.

A method for transmitting screen frames of the invention is applied to a network system consisting of a first electronic device, a second electronic device, and at least one third electronic device. The method includes steps of: transmitting a full screen frame from the first electronic device to the second electronic device via network packets; transmitting at least one rectangle data from the first electronic device to the second electronic device via network packets, wherein the rectangle data includes information of a combined region corresponding to the changed areas in the full screen frame; the second electronic device receiving the full screen frame and the rectangle data and, in accordance with each received network packet, sending an acknowledgement to the first electronic device; and the third electronic device intercepting the full screen frame and the rectangle data to reconstruct an updated screen frame and display the same.

The invention also discloses a system for transmitting screen frames from one to many terminals via network packets that is applied to a network system; the system for transmitting screen frames includes a first electronic device, a second electronic device, and a third electronic device. The first electronic device is used for transmitting a full screen frame and at least one rectangle data including information of a combined region corresponding to the changed areas in the full screen frame. The second electronic device is used for receiving the full screen frame and the rectangle data, and sending an acknowledgement to the first electronic device in accordance with each received network packet. The third electronic device is used for intercepting the full screen frame and the rectangle data to reconstruct an updated screen frame and display the same.

The invention also discloses a receiving device for transmitting screen frames from one to many terminals that can be applied to the aforementioned system. The receiving device receives the full screen frame and the rectangle data, and operates with an image output device for outputting the received screen frame. The receiving device includes a network interface, a computation unit, a first buffer, and a video interface. The network interface and the network are signal-connected for receiving the full screen frame and the rectangle data. The computation unit is used for decoding the full screen frame and the rectangle data to reconstruct an updated screen frame. The first buffer is used for storing the updated screen frame, and the video interface is signal-connected to the image output device for outputting the updated screen frame.

When using the method, system and receiving device for transmitting screen frames from one to many terminals according to the invention, the complete full screen frame needs to be transmitted only once, and only changed portions in the screen frame are transmitted thereafter; thus, the data quantity of screen frames for transmission is effectively reduced. Moreover, the data of screen frames is transmitted on a one-to-one basis, which solves the problem of high error rate in broadcast packet transmission, and since any receiving terminal can intercept network packets during transmission, the purpose of transmitting from one to many terminals is achieved.

### BRIEF DESCRIPTION OF THE DRAWINGS

FIG. 1 illustrates the infrastructure of a system for transmitting screen frames from one to many terminals according to an embodiment of the invention.

FIG. 2 is a flowchart illustrating the transmission of a screen frame in a method for transmitting screen frames from one to many terminals according to an embodiment of the invention.

FIG. 3 is a flowchart illustrating the receiving process of a screen frame in a method for transmitting screen frames from one to many terminals according to an embodiment of the invention.

FIG. 4 is another flowchart illustrating the receiving process of a screen frame in a method for transmitting screen frames from one to many terminals according to an embodiment of the invention.

FIG. 5 is a block diagram illustrating a receiving device for transmitting screen frames from one to many terminals according to an embodiment of the invention.

FIG. 6 is a schematic diagram illustrating changed rectangles, divided rectangles, and overlapped rectangles.

### DETAILED DESCRIPTION OF THE INVENTION

The preferred embodiments of a method, a system, and a receiving device for transmitting screen frames from one to many terminals according to the invention will be described in detail, with reference to the drawings in which the like reference numerals refer to the like elements.

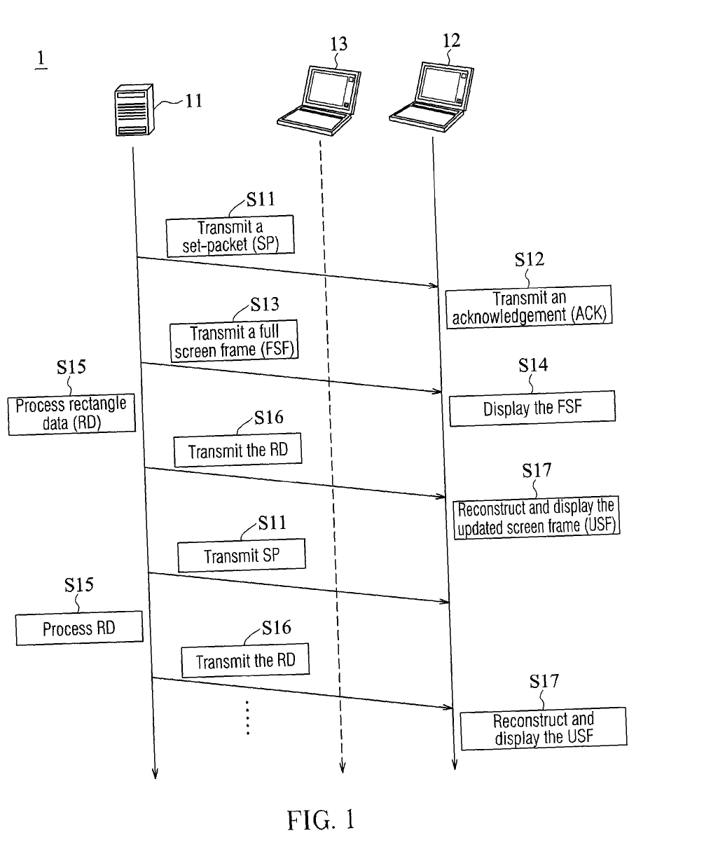

Referring to FIG. 1, a system for transmitting screen frames from one to many terminals 1 according to an embodiment of the invention includes a first electronic device 11, a second electronic device 12, and a third electronic device 13; the three devices connect to one another by network signals. The first electronic device 11 can be a computer, or another type of electronic device with functions of outputting screen frames and connecting to network systems via signals. The second electronic device 12 and the third electronic device 13 can also be computers or other types of electronic devices with functions of displaying screen frames and connecting to network systems via signals.

WLAN in IEEE 802.11 series is used as an example for illustration purposes. A WLAN formed by the first electronic device 11, the second electronic device 12 and the third electronic device 13 has two transmission modes: ad-hoc mode or infrastructure mode. Under the infrastructure mode, the first electronic device 111 must transmit information to the second electronic device 12 and the third electronic device 13 through an access point. That negatively affects the transmission efficiency and therefore real-time transmission cannot be performed. In order to transmit data using the ad-hoc mode, the first electronic device 11, the second electronic device 12, and the third electronic device 13 must have the same setting. For that reason, the first electronic device 11 first sends a set-packet (SP) (S11) to the second electronic device 12, wherein the set-packet includes setting information including a service set identifier (SSID) and a channel number. Since the first electronic device 11 doesn't send the set-packet in the form of broadcast packet, the second electronic device 12 checks the set-packet after receiving it and sends an acknowledgement (ACK) (S12) to the first electronic device 11 if the set-packet is correct. All of the network packets transmitted to the second electronic device 12 from the first electronic device 11 are checked by the second electronic device 12 and ACKs are sent back according thereto; therefore, the process will not be stated repeatedly in the description below.

When the first electronic device 111 and the second electronic device 12 are in the same WLAN according to the setting information in the set-packet, the first electronic device 11 can begin transmitting a screen frame. First, the first electronic device 11 transmits a full screen frame (FSF) to the second electronic device 12 (S13), and the second electronic device 12 displays the FSF after receiving it (S14). Then, the first electronic device 11 transmits only the information of a combined region, which corresponds to the changed areas in the FSF, or portions of the FSF with overlapped areas having been removed. Different rectangle data (RD) are thus formed (S15) and transmitted to the second electronic device 12 (S16). The second electronic device 12 reconstructs an updated screen frame (USF) according to the RD for display (S17). Steps S15, S16, and S17 are repeated for effectively transmitting the screen frame of the first electronic device 11 to the second electronic device 12.

Though the aforementioned transmitting process is data transmission between the first electronic device 11 and the second electronic device 12, the third electronic device 13 is able to intercept the network packets that are transmitted between the first electronic device 11 and the second electronic device 12. The third electronic device 13 scans all usable transmitting channels in WLAN and intercepts the set-packet for setting up the network configuration of the third electronic device 13 according to the SSID and channel number in the set-packet, thereby effectively intercepting the FSF and RD to reconstruct and display updated screen frames. Therefore, the first electronic device 11 periodically transmits the set-packet so that the third electronic device 13 can intercept the set-packet at anytime to receive the screen frame.

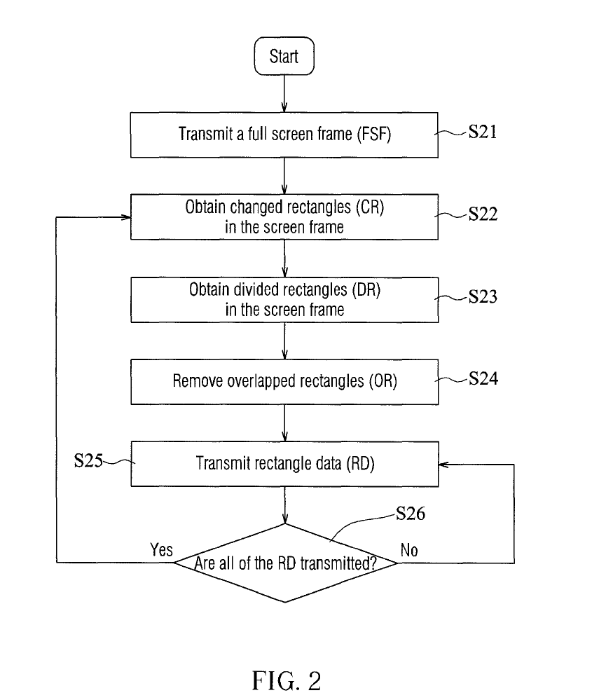

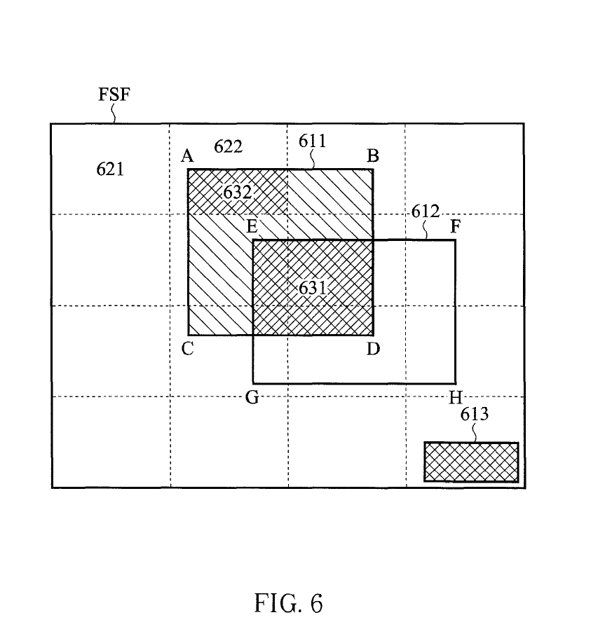

The processing of rectangle data (RD) by the first electronic device 111 and the reconstruction of updated screen frame by the second electronic device 12 and the third electronic device 13 will be described in detail. Referring to FIGS. 2 to 4, a method for transmitting screen frames from one to many terminals according to an embodiment of the invention is disclosed. FIG. 2 illustrates the processing of RD by the first electronic device 11. First, the first electronic device 11 transmits a FSF (S21), and as shown in FIG. 6, the second electronic device 12 obtains a complete screen frame. Next, the first electronic device 11 obtains changed areas in the previous FSF (S22). The first electronic device 11 can get the changed areas, which are represented in a form of at least one changed rectangles (CR) and as will be hereafter referred to, of the screen frame directly from a management program related to driving video display in the operating system, for example, rectangle ABCD (rectangle 611), rectangle EFGH (rectangle 612), and rectangle 613. The first electronic device 111 can directly transmit data related to CR to the second electronic device 12, wherein each data related to CR includes the rectangle basic data and rectangle image data of the CR, which will be referred to as rectangle data (RD) hereafter. Furthermore, the rectangle basic data includes the position coordinates of a single rectangle so that the receiving terminal will know what the changed position and area of the screen frame is; and the rectangle image data denotes the screen frame inside the rectangle. To reduce the data needed to be transmitted, the rectangle image data can be encoded by run length coding, and can be decoded after the receiving terminal has received it.

Referring to FIG. 6, assuming that the rectangle 611 is on top of the rectangle 612, the overlapped portion, which is the gritted rectangle 631, will display merely the image data of rectangle 611 whereas the image data of rectangle 612 in the rectangle 631 area will not be displayed. Thereby the image data of this portion can be removed to reduce the data for transmission; the overlapped and undisplayed area is called an overlapped rectangle (OR). One of the removal methods is to fill in 0 or 1 continuously, and by way of run length coding, the data quantity can be effectively reduced. Thus, the first electronic device 11 can remove overlapped rectangles (S24) before transmitting RD.

Moreover, since the third electronic device 13 can enter the network at anytime to receive the screen frame, the third electronic device 13 may not have received the FSF transmitted in step S21. In order to give the later entered third electronic device 13 a complete screen frame, the first electronic device 11 divides a current screen frame into a plurality of divided rectangles (DR) (S23), and sequentially attaches information of one of the divided rectangles in each CR transmission. Thus, after a cycle, the third electronic device 13 will receive a complete screen frame. FIG. 6 illustrates a screen frame that is divided into 16 divided rectangles, such as rectangle 621 and rectangle 622. The number of divided rectangles can be altered accordingly in consideration of factors like network bandwidth or the cycle of reconstructing a complete screen frame. In addition, undisplayed overlapped rectangles may also exist between divided rectangles and changed rectangles due to overlapping of DR and CR; for example, when transmitting DR 622 and CR 611 at the same time, an OR 632 is generated. Therefore, the problem of changed rectangles overlapping divided rectangles is taken into consideration during the removal of overlapped rectangles (S24).

Next, the first electronic device 11 transmits each rectangle data (RD) (S25) after notifying the receiving terminal the number of RDs for transmission, and determines whether all of the RDs have been transmitted (S26). If the RDs have not all been transmitted, return to step S25 for sending the RDs one by one, and if all of the RDs have been transmitted, return to step S22 and obtain changed areas in the screen frame, which are represented in a form of changed rectangles.

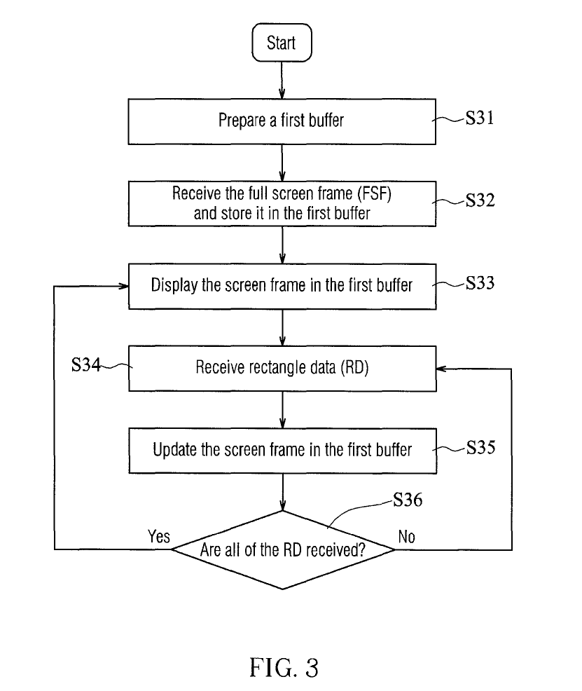

Referring to FIG. 3, a flowchart describing the receiving process and the reconstruction of screen frames by a receiving terminal (the second and third electronic devices 12, 13) is shown. First, a first buffer that is about the size of a screen frame is prepared (S31). Secondly, a FSF transmitted by the first electronic device 111 is received and stored in the first buffer (S32) before being displayed (S33). Next, a RD that includes information of a changed rectangle and a divided rectangle is received (S34), and the screen frame stored in the first buffer is updated according to the rectangle basic data and rectangle image data included in the RD (S35). If the RDs have not all been received (S36), return to step S34 to continue receiving RD, but if all of the RDs have been received, which means the screen frame stored in the first buffer has been reconstructed to an updated screen frame, then return to step S33 to display the updated screen frame.

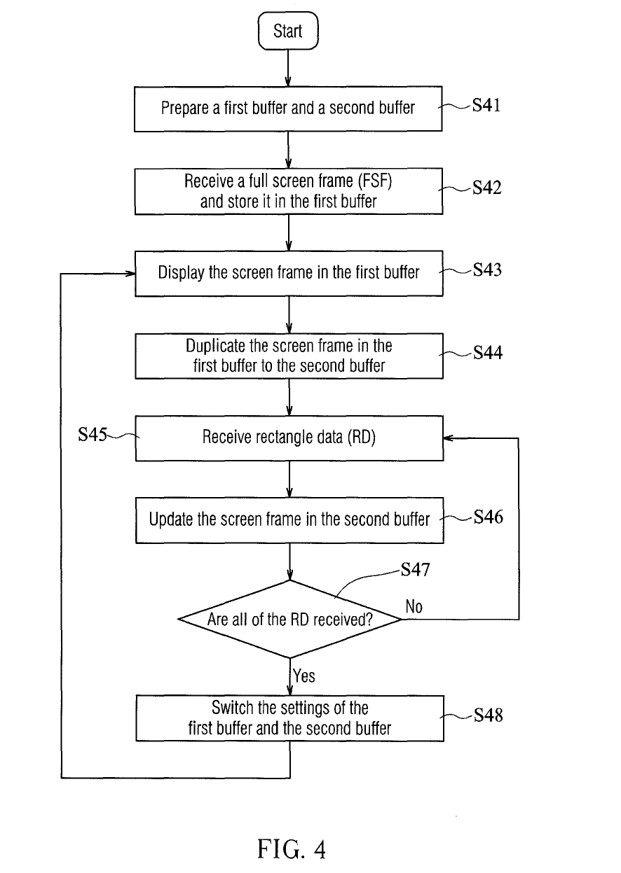

The receiving terminal can use two buffers to temporarily store the screen frame so that the receiving process and the reconstruction of screen frame run smoothly; the flowchart thereof is shown in FIG. 4. First, a first buffer and a second buffer are prepared (S41), and then a FSF received is stored in the first buffer (S42) and displayed (S43). Next, the screen frame stored in the first buffer is duplicated to the second buffer (S44). Afterwards, RD starts to be received (S45) and the screen frame stored in the second buffer is updated and reconstructed according to the rectangle basic data and rectangle image data; steps S45, S46, and S47 are repeated until all of the RDs are completely received and the screen frame stored in the second buffer is reconstructed into an updated screen frame. The settings of the first buffer and the second buffer are then switched (S48), wherein the second buffer is set to be the first buffer and the first buffer is set to be the second buffer, and the screen frame stored in the first buffer now is displayed by returning to step S43. The screen frame can be updated continuously by repeating these steps.

It is to be noted that the image data at a certain position stored in the first buffer can be duplicated to the corresponding position in the second buffer if the image data in the rectangle data received by the receiving terminal is incomplete, thereby improving the quality of the output screen frame.

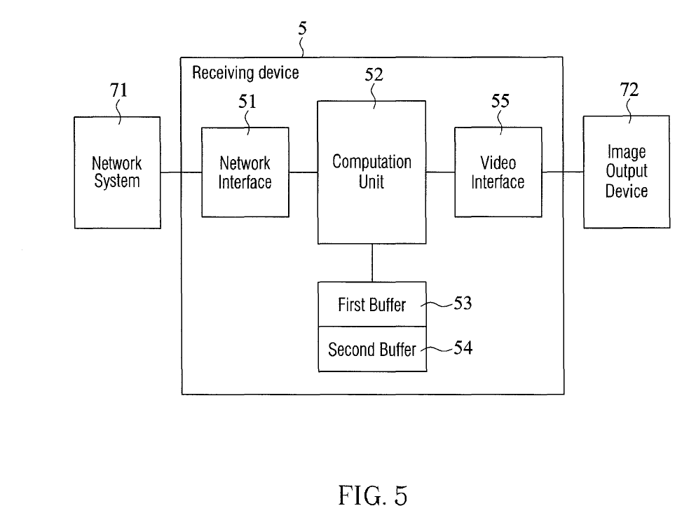

The method for transmitting screen frames from one to many terminals in the aforementioned embodiment can be implemented by software, for example, a computer executing each processing step after loading the software therein. Alternatively, the method can be implemented by hardware. As shown in FIG. 5, the method is implemented on a receiving device 5, which operates with an image output device 72 to achieve the same purpose and function. The image output device can be a device that outputs video, such as a projector, a monitor, or a television.

The receiving device 5 includes a network interface 51, a computation unit 52, a first buffer 53, a second buffer 54, and a video interface 55. The network interface 51 is used for signal-connection with a network 71 to receive the data related to a screen frame that is transmitted from the first electronic device 11. The computation unit 52 is used for executing each step in the aforementioned method to reconstruct an updated screen frame, the details of which will not be further described hereinafter. The first buffer 53 is used for storing the updated screen frame that is for displaying, and the second buffer 54 is used for storing a screen frame that is not completely updated. The video interface 55 is used for connecting with the image output device 72 to output the screen frame stored in the first buffer 53.

The method, system and receiving device for transmitting screen frames from one to many terminals according to the invention only need to transmit the complete full screen frame once, and the remaining transmissions are for portions of the screen frame that have changed, thereby the data quantity of screen frame transmitted is effectively reduced. Moreover, the data quantity of transmission is further reduced by removing the image data of overlapped rectangles and encoding the image data by way of run length coding that is easy to compute and maintains quality. In addition, the data of screen frames is transmitted on one-to-one basis, which solves the problem of high error rate in broadcast packet transmission, and so the third electronic device can intercept a complete screen frame, whereby the purpose of transmitting screen frames from one to many terminals is achieved. At the same time, the first electronic device attaches divided rectangles in transmissions of changed rectangles so that the receiving terminal can enter at anytime to receive the screen frame and reconstruct a complete screen frame after a cycle.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. For example, the aforementioned embodiments are described in the context of wireless local area network, but a person skilled in the art can adapt it to wired local area network and omit the process of transmitting set-packets which are characteristic of wireless local area network. Therefore, the scope of the appended claims should be accorded the broadest interpretation so as to encompass all such modifications and similar arrangements.

What is claimed is:

1. A method for transmitting screen frames from one to many terminals, which is applied to a network system having a first electronic device, a second electronic device, and at least one third electronic device, the method comprising:
the first electronic device transmitting a full screen frame to the second electronic device via network packets;
the first electronic device transmitting at least one rectangle data to the second electronic device via network packets, the rectangle data including information of a combined region corresponding to changed areas in the full screen frame without overlapped areas, the changed areas being represented in a form of at least one changed rectangles;
the second electronic device receiving the full screen frame and the rectangle data, and transmitting an acknowledgement to the first electronic device in accordance with each received network packet; and
the third electronic device intercepting the full screen frame and the rectangle data for reconstructing an updated screen frame and displaying the same.

2. The method for transmitting screen frames from one to many terminals as described in claim 1, wherein the step of transmitting a full screen frame is only executed once.

3. The method for transmitting screen frames from one to many terminals as described in claim 1, further comprising:
the first electronic device dividing a current screen frame into a plurality of divided rectangles and the rectangle data further including information of one of the plurality of divided rectangles.

4. The method for transmitting screen frames from one to many terminals as described in claim 3, further comprising:
removing at least one overlapped rectangle before transmitting the rectangle data to prevent information of the overlapped rectangle from being sent by the first electronic device, the overlapped rectangle being area of a changed rectangle overlapped by another changed rectangle, or area of one of the divided rectangles overlapped by a changed rectangle.

5. The method for transmitting screen frames from one to many terminals as described in claim 1, wherein the rectangle data includes a rectangle basic data and a rectangle image data, wherein the rectangle basic data includes position coordinates of the corresponding rectangle.

6. The method for transmitting screen frames from one to many terminals as described in claim 5, wherein each of the second electronic device and the at least one third electronic device comprises a first buffer used to store the full screen frame and display the same, and a second buffer used to store the full screen frame and the rectangle image data; the settings of the first buffer and the second buffer are switched after the second buffer has received all of the rectangle image data.

7. The method for transmitting screen frames from one to many terminals as described in claim 6, wherein the full screen frame stored in the second buffer is a duplicate of the full screen frame stored in the first buffer.

8. The method for transmitting screen frames from one to many terminals as described in claim 6, wherein the image corresponding to a certain position is duplicated to the second buffer from the first buffer when portion of the rectangle image data at the certain position in the second buffer is incomplete.

9. The method for transmitting screen frames from one to many terminals as described in claim 5, wherein the rectangle image data is encoded and decoded by way of run length coding.

10. The method for transmitting screen frames from one to many terminals as described in claim 1, wherein the network system is a wireless local area network (WLAN) or a wired local area network.

11. The method for transmitting screen frames from one to many terminals as described in claim 10, wherein the WLAN transmission standard is the IEEE 802.11 series standard.

12. The method for transmitting screen frames from one to many terminals as described in claim 11, further comprising:
the first electronic device transmitting a set-packet periodically, the set-packet including a service set identifier and a channel number; and
the at least one third electronic device scanning all usable transmitting channels in WLAN to intercept the set-packet, and receiving the full screen frame and the rectangle data according to the service set identifier and the channel number in the set-packet.

13. A system for transmitting screen frames from one to many terminals, which is applied to a network system, the system for transmitting screen frames from one to many terminals comprising:
a first electronic device for transmitting a full screen frame and at least one rectangle data via network packets, the rectangle data including information of a combined region corresponding to changed areas in the screen frame without overlapped portion, the changed areas being represented in a form of at least one changed rectangles;
a second electronic device for receiving the full screen frame and the rectangle data, and transmitting an acknowledgement to the first electronic device in accordance with each received network packet; and
at least one third electronic device for intercepting the full screen frame and the rectangle data for reconstructing an updated screen frame and displaying the same.

14. The system for transmitting screen frames from one to many terminals as described in claim 13, wherein the first electronic device divides a current screen frame into a plurality of divided rectangles, and the rectangle data further includes information of one of the plurality of divided rectangles.

15. The system for transmitting screen frames from one to many terminals as described in claim 14, wherein information of at least one overlapped rectangle is removed from the rectangle data; the overlapped rectangle is area of a changed rectangle overlapped by another changed rectangle, or area of one of the divided rectangles overlapped by a changed rectangle.

16. The system for transmitting screen frames from one to many terminals as described in claim 13, wherein the rectangle data includes a rectangle basic data and a rectangle image data, wherein the rectangle basic data includes position coordinates of the corresponding rectangle.

17. The system for transmitting screen frames from one to many terminals as described in claim 16, wherein each of the second electronic device and the at least one third electronic device comprises a first buffer for storing the full screen frame and the rectangle image data.

18. The system for transmitting screen frames from one to many terminals as described in claim 16, wherein each of the second electronic device and the at least one third electronic device comprises a first buffer used to store the full screen frame and display the same, and a second buffer used to store the full screen frame and the rectangle image data; the settings of the first buffer and the second buffer are switched after the second buffer has received all of the rectangle image data.

19. The system for transmitting screen frames from one to many terminals as described in claim 18, wherein the full screen frame stored in the second buffer is a duplicate of the full screen frame stored in the first buffer.

20. The system for transmitting screen frames from one to many terminals as described in claim 18, wherein the image corresponding to a certain position is duplicated to the second buffer from the first buffer when portion of the rectangle image data at the certain position in the second buffer is incomplete.

21. The system for transmitting screen frames from one to many terminals as described in claim 16, wherein the rectangle data is encoded and decoded by way of run length coding.

22. The system for transmitting screen frames from one to many terminals as described in claim 13, wherein the network system is a wireless local area network (WLAN) or a wired local area network.

23. The system for transmitting screen frames from one to many terminals as described in claim 22, wherein the WLAN transmission standard is the IEEE 802.11 series standard.

24. The system for transmitting screen frames from one to many terminals as described in claim 23, wherein the first electronic device further transmits periodically a set-packet including a service set identifier and a channel number, and the at least one third electronic device scans all usable transmitting channels in WLAN to intercept the set-packet and receives the full screen frame and the rectangle data according to the service set identifier and the channel number in the set-packet.

25. The system for transmitting screen frames from one to many terminals as described in claim 13, wherein the first electronic device is an electronic device with functions of outputting screen frames and signal-connecting to network systems.

26. The system for transmitting screen frames from one to many terminals as described in claim 25, wherein the electronic device is a computer.

27. The system for transmitting screen frames from one to many terminals as described in claim 13, wherein each of the second electronic device and the at least one third electronic device is an electronic device with functions of displaying screen frames and signal-connecting to network systems.

28. The system for transmitting screen frames from one to many terminals as described in claim 27, wherein the electronic device is a computer.

29. A receiving device for transmitting screen frames from one to many terminals, which is applied to a system for transmitting screen frames from one to many terminals, the system comprising a first electronic device and a second electronic device signal-connected to one another via a network system, wherein the first electronic device transmits via network packets a full screen frame and at least one rectangle data having information of a combined region corresponding to changed areas in the full screen frame without overlapped portion, which the changed areas are represented in a form of at least one changed rectangles, and the second electronic device receives the full screen frame and the rectangle data and transmits an acknowledgement to the first electronic device in accordance with each received network packet, the receiving device comprising:
a network interface signal-connected to the network system for receiving the full screen frame and the rectangle data;
a computation unit for decoding the full screen frame and the rectangle data to reconstruct an updated screen frame;
a first buffer for storing the updated screen frame; and
a video interface signal-connected to an image output device for outputting the updated screen frame.

30. The receiving device for transmitting screen frames from one to many terminals as described in claim 29, wherein the first electronic device divides a current screen frame into a plurality of divided rectangles, and the rectangle data further includes information of one of the plurality of divided rectangles.

31. The receiving device for transmitting screen frames from one to many terminals as described in claim 29, wherein information of at least one overlapped rectangle is removed from the rectangle data; the overlapped rectangle is area of a changed rectangle overlapped by another changed rectangle, or area of one of the divided rectangles overlapped by a changed rectangle.

32. The receiving device for transmitting screen frames from one to many terminals as described in claim 29, further comprising:
a second buffer for storing a screen frame that has not been completely updated.

33. The receiving device for transmitting screen frames from one to many terminals as described in claim 29, wherein the rectangle data includes a rectangle image data that is encoded and decoded by way of run length coding.

34. The receiving device for transmitting screen frames from one to many terminals as described in claim 29, wherein the network system is a wireless local area network (WLAN) or a wired local area network.

35. The receiving device for transmitting screen frames from one to many terminals as described in claim 34, wherein the WLAN transmission standard is the IEEE 802.11 series standard.

36. The receiving device for transmitting screen frames from one to many terminals as described in claim 35, wherein the first electronic device further transmits periodically a set-packet including a service set identifier and a channel number, and the receiving device scans all usable transmitting channels in WLAN to intercept the set packet and receives the full screen frame and the rectangle data according to the service set identifier and the channel number in the set-packet.
